(19) United States
(12) Patent Application Publication
(10) Pub. No.: US 2023/0178744 A1
(43) Pub. Date: Jun. 8, 2023

(54) CROSSLINKED BINDER FOR ALL SOLID-STATE BATTERY AND METHOD OF PREPARING SAME

(71) Applicants: HYUNDAI MOTOR COMPANY, Seoul (KR); KIA CORPORATION, Seoul (KR); Seoul National University R&DB Foundation, Seoul (KR)

(72) Inventors: Seung Ho Choi, Hanam-si (KR); Sang Heon Lee, Yongin-si (KR); Jang Wook Choi, Seoul (KR); Ji Hoon Oh, Seoul (KR)

(73) Assignees: HYUNDAI MOTOR COMPANY, Seoul (KR); KIA CORPORATION, Seoul (KR); Seoul National University R&DB Foundation, Seoul (KR)

(21) Appl. No.: 18/075,852

(22) Filed: Dec. 6, 2022

(30) Foreign Application Priority Data
Dec. 7, 2021 (KR) 10-2021-0173901

(51) Int. Cl. H01M 4/62; H01M 4/04; H01M 4/40

(52) U.S. Cl. CPC H01M 4/622; H01M 4/0404; H01M 4/405; H01M 4/0407; H01M 2004/027

(57) ABSTRACT

The present disclosure relates to a binder for a solid-state battery and a manufacturing method thereof. The binder may include a polymer comprising a carbonyl group and a linker comprising amino groups at both ends.

### CROSS REFERENCE TO RELATED APPLICATION

The present application claims priority to Korean Patent Application No. 10-2021-0173901, filed Dec. 7, 2021 in the Korean Intellectual Property Office, the entire contents of which is incorporated herein for all purposes by this reference.

### DISCLOSURE

### Technical Field

The present disclosure relates to a crosslinked binder for an all-solid-state battery and manufacturing method thereof.

### BACKGROUND

An anodeless all-solid-state battery is a system capable of achieving high energy density without using an anode active material. When a battery is charged, lithium ions migrating from a cathode are precipitated and stored in the form of lithium metal on the surface of an anode current collector. A lithium-friendly intermediate layer is interposed between a solid electrolyte layer and the anode current collector so that lithium metal can be uniformly deposited on the anode current collector.

Generally, the intermediate layer of an anodeless all solid-state battery includes a metal capable of forming an alloy with lithium and a binder. However, during the charging, the metal present in the intermediate layer reacts with lithium ions and thus expands, resulting in a defect in the intermediate layer. This causes a serious problem in the stability of the anodeless all-solid-state battery.

Therefore, in order to improve the lifespan and stability of the anodeless all-solid-state battery, a highly elastic binder capable of efficiently controlling the expansion of the intermediate layer during the charging and discharging is required.

### SUMMARY

An objective of the present disclosure is to provide a highly elastic binder capable of minimizing the effects of volumetric expansion and contraction of an electrode during charging and discharging of a battery.

However, the objectives of the present disclosure are not limited the one described above. The objectives of the present disclosure will become more apparent from the following description and will be realized with components recited in the claims and combinations of the components.

According to one embodiment of the present disclosure, there is provided a binder for a lithium secondary battery including: a polymer including a carbonyl group; and a linker including amino groups at both ends.

The binder may be in state of crosslinked.

All or a part of an oxygen atom of the carbonyl group may be substituted with a nitrogen atom of the amino groups such that a first end of the linker may be bonded to the carbonyl group of one polymer and a second end of the linker may be bonded to the carbonyl group of another polymer.

The polymer may include a polyurethane-based polymer.

The linker may include at least one selected from the group consisting of aminophenyl disulfide, polyethyleneimine, and combinations thereof.

The binder may be represented by Formula 1.

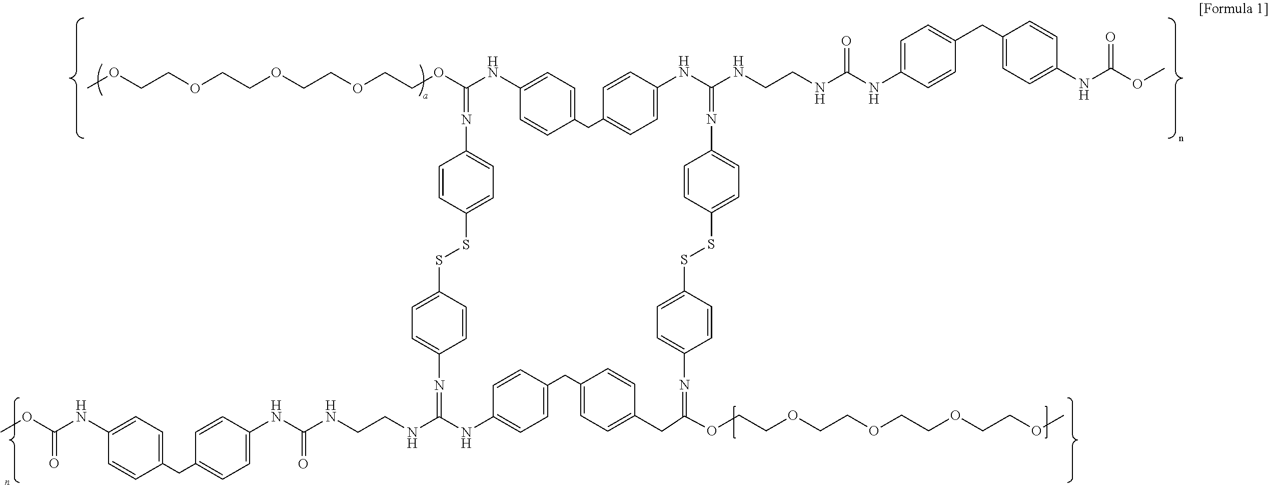

wherein n may be a number of 10 to 10,000 and a may be a number of 1 to 100.

According to one embodiment of the present disclosure, there is provided a lithium secondary battery including an anode current collector, an intermediate layer disposed on the anode current collector, a solid electrolyte layer disposed on the intermediate layer, a cathode active material layer disposed on the solid electrolyte layer, and a cathode current collector disposed on the cathode active material layer. The intermediate layer may include a metal capable of forming an alloy with lithium and the binder described above.

The metal may include at least one selected from the group consisting of gold (Au), platinum (Pt), palladium (Pd), silicon (Si), silver (Ag), aluminum (Al), bismuth (Bi), tin (Sn), zinc (Zn), and combinations thereof.

According to one embodiment of the present disclosure, there is provided a method of preparing a binder for a lithium secondary battery including: reacting a polymer including carbonyl groups with a linker including amino groups at both ends in the presence of an acid catalyst.

The acid catalyst may include an acetic acid solution having a concentration of about 1% to 50% by volume.

The acid catalyst may have a pH value of about pH 3 and pH 6.

According to the present disclosure, it is possible to obtain a highly elastic binder for a lithium secondary battery, the binder being capable of minimizing the effects of volumetric expansion and contraction of electrodes, attributable to charging and discharging of the battery.

According to the present disclosure, it is possible to obtain a lithium secondary battery improved in lifespan and stability.

However, the advantages of the present disclosure are not limited thereto. It should be understood that the advantages of the present disclosure include all effects that can be inferred from the description given below.

### BRIEF DESCRIPTION OF THE DRAWINGS

The above and other objects, features, and other advantages of the present disclosure will be more clearly understood from the following detailed description taken in conjunction with the accompanying drawings, in which:

FIG. 1 shows a cross-sectional view of an all-solid-state battery of the present disclosure;

FIG. 2 shows a state in which the all-solid-state battery of FIG. 1 is charged;

FIG. 3 shows Fourier-transform infrared spectroscopy (FT-IR) analysis on a binder according to a preparation example;

FIG. 4 shows Raman spectroscopy analysis of a binder according to a preparation example;

FIG. 5 shows first charging and discharging cycle of half cells according to Example, Comparative example 1, and Comparative example 2; and

FIG. 6 shows cumulative efficiency of half cells according to Example, Comparative Example 1, and Comparative Example 2.

### DETAILED DESCRIPTION

Above objectives, other objectives, features, and advantages of the present disclosure will be readily understood from the following preferred embodiments associated with the accompanying drawings. However the present disclosure is not limited to the embodiments described herein and may be embodied in other forms. The embodiments described herein are provided so that the disclosure can be made thorough and complete and that the spirit of the present disclosure can be fully conveyed to those skilled in the art.

Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise.

It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween.

Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. As used herein, the term “about” means modifying, for example, lengths, degrees of errors, dimensions, the quantity of an ingredient in a composition, concentrations, volumes, process temperature, process time, yields, flow rates, pressures, and like values, and ranges thereof, refers to variation in the numerical quantity that may occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. Whether modified by the term “about” the claims appended hereto include equivalents to these quantities. The term “about” further may refer to a range of values that are similar to the stated reference value. In certain embodiments, the term “about” refers to a range of values that fall within 10, 9, 8, 7, 6, 5, 4, 3, 2, 1 percent above or below the numerical value (except where such number would exceed 100% of a possible value or go below 0%) or a plus/minus manufacturing/measurement tolerance of the numerical value. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In order to improve the stability of an electrode during charging and discharging of a battery, a binder having a high elasticity and a high bonding force is required. The elasticity is a very important property for efficiently dispersing the stresses generated when an electrode material expands and for suppressing defects occurred inside the electrode.

The present disclosure features that a binder where one-dimensional or two-dimensional polymer is crosslinked in three dimension is used. The addition of a small amount of a crosslinking agent to the binder is a highly effective way to strengthen the network between the binder without damaging the unique properties of the electrodes.

The binder according to the present disclosure may include a polymer having carbonyl groups and a linker having amino groups at both ends. All or a part of an oxygen atom of the carbonyl groups may be substituted with a nitrogen element of the amino groups such that a first end of the linker is bonded to the carbonyl group of one polymer and a second end of the linker is bonded to the carbonyl group of another polymer. The binder may be in a crosslinked state.

The polymer may include a polyurethane-based polymer. For example, the polymer may include Spandex.

The linker may include at least one selected from the group consisting of aminophenyl disulfide, polyethyleneimine, and combinations thereof.

The binder may include one or more compounds represented by Formula 1.

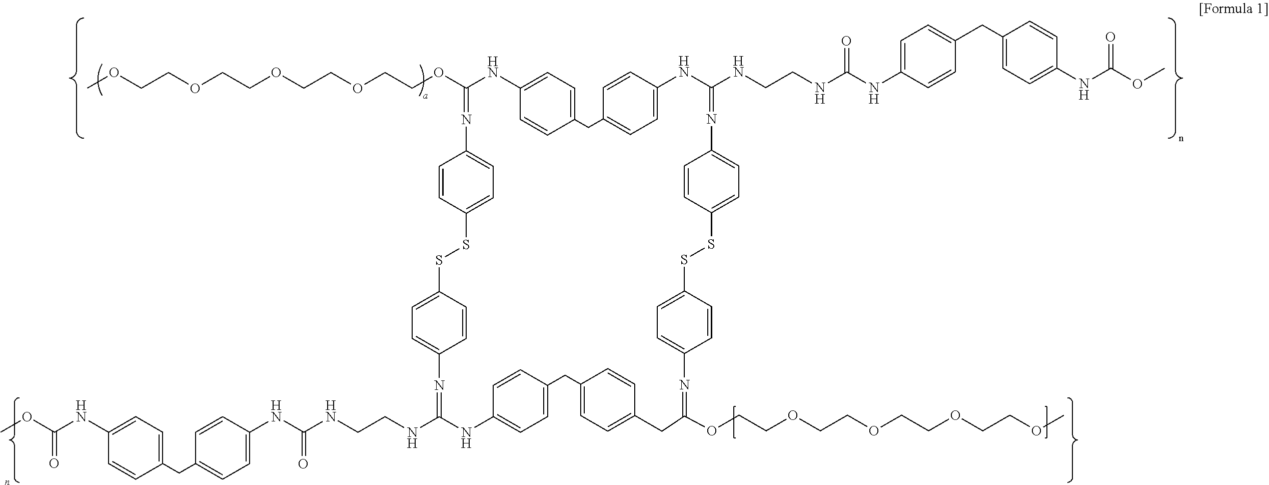

In Formula 1, n is a number of 10 to 10,000 and a is a number of 1 to 100. When n and a fall within the numerical ranges mentioned above, the molecular weight of the binder satisfies an appropriate range, thereby improving crosslinking density, mechanical properties, and the like.

Formula 1 represents compounds in which two polymers are crosslinked but the binder is not limited thereto. The binder should be interpreted to a compound in which two or more polymers are crosslinked via the linker to form a three-dimensional network structure.

According to one embodiment of the present disclosure, there is provided a method of preparing the binder for a lithium secondary battery including: reacting the polymer including carbonyl groups with the linker including amino groups at both ends in the presence of an acid catalyst. The reaction may be carried out as in Scheme 1 shown below.

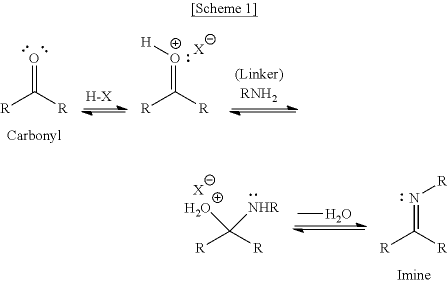

The carbonyl group (—C═O) present in the polymer and the amino group (—NH₂) present in the linker may be reacted in the presence of the acid catalyst to form a —C═N bond. First, the acid catalyst may impart an electrical characteristic to the oxygen atom of the carbonyl group (—C═O). This may allow the carbonyl group (—C═O) to act as an electrophilic group and to undergo a nucleophilic substitution reaction with the linker having amino groups which are nucleophilic. Consequently, the oxygen atom in the carbonyl group (—C═O) is separated, and a —C═N group is famed.

The acid catalyst may include an acetic acid solution having a concentration of about 1% to 50% by volume. The acid catalyst may have a pH value of about pH 3 and pH 6.

The reaction of the polymer with the linker may take place in a solvent. Examples of the solvent are not particularly limited, and any solvent that dissolve the polymer can be used. One example of the solvent may include N-methyl-2-pyrrolidone (NMP).

The binder may be prepared by crosslinking polymers that are not a monomer as starting materials. Therefore, the binder can have improved elasticity while maintaining the inherent physical properties of the polymers.

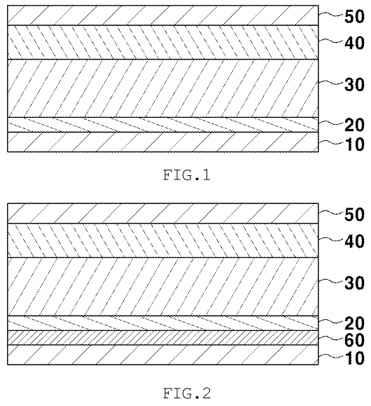

FIG. 1 shows a cross-sectional view of an all-solid-state battery according to the present disclosure. The all-solid-state battery may include an anode current collector 10, an intermediate layer 20 disposed on the anode current collector 10, a solid electrolyte layer 30 disposed on the intermediate layer 20, a cathode active material layer 40 disposed on the solid electrolyte layer 30, and a cathode current collector 50 disposed on the cathode active material layer 40.

The anode current collector 10 may be an electrically conductive plate-shaped substrate. Specifically, the anode current collector layer 10 may be in the form of a sheet, a thin film, or a foil.

The anode current collector 10 may include a material that does not react with lithium. The anode current collector 10 may include at least one selected from the group consisting of Ni, Cu, stainless steel (SUS), and combinations thereof.

The intermediate layer 20 includes a metal capable of forming an alloy with lithium, and a binder.

The metal may include at least one selected from the group consisting of gold (Au), platinum (Pt), palladium (Pd), silicon (Si), silver (Ag), aluminum (Al), bismuth (Bi), tin (Sn), zinc (Zn), and combinations thereof.

The intermediate layer 20 may further include a carbon material. The carbon material may include amorphous carbon.

FIG. 2 shows a state in which the all-solid-state battery of FIG. 1 is charged. Referring to FIG. 1, the all-solid-state battery may include a lithium layer 60 disposed between the anode current collector 10 and the intermediate layer 20.

In the all-solid-state battery, lithium ions migrate to the intermediate layer 20 through the solid electrolyte layer 30. The lithium ions react with the metal M to form an M-Li alloy between the anode current collector 10 and the intermediate layer 20. While the charging continues, the lithium is uniformly deposited or precipitated on the M-Li alloy to form the lithium layer 60. The lithium layer 60 may include at least lithium metal.

Since the binder has a three-dimensionally crosslinked structure, the binder has good elasticity. Thus, it is possible to effectively relieve stress attributable to volumetric expansion during the formation of the M-Li alloy and the lithium layer 60.

The solid electrolyte layer 30 may be interposed between the cathode active material layer 40 and the anode current collector 10 and may conduct lithium ions.

The solid electrolyte layer 30 may include a solid electrolyte material having a lithium ion conductivity.

The solid electrolyte may include at least one selected from the group consisting of an oxide-based solid electrolyte, a sulfide-based solid electrolyte, a polymer electrolyte, and combinations thereof. However, it is preferable to use a sulfide-based solid electrolyte having high lithium ion conductivity. The sulfide-based solid electrolyte is not particularly limited, but examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (here, m and n are positive integers, and Z is any one of Ge, Zn, and Ga), Li₂S—GeS₂, Li₂S—SiS₂—Li₃PO₄, Li₂S—SiS₂—LiₓMO_{y} (here, x and y are positive integers, and M is any one of P, Si, Ge, B, Al, Ga, and In), and Li₁₀GeP₂S₁₂.

The oxide-based solid electrolyte may include perovskite-type LLTO (Li₃ₓLa_{2/3-x}TiO₃) and phosphate-based NASICON-type LATP (Li₁₊ₓAlₓTi₂₋ₓ(PO₄)₃) The polymer electrolyte may include a gel polymer electrolyte, a solid polymer electrolyte, or the like.

The cathode active material layer 40 reversibly absorbs and releases lithium ions. The cathode active material layer 40 may include a cathode active material, a solid electrolyte, a conductive material, a binder, and the like.

The cathode active material may include an oxide active material or a sulfide active material.

The oxide active material may include a rock salt layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock salt layer-type active material in which transition metals are partially substituted with dissimilar metals, such as LiNi_{0.8}Co_{(0.2-x)}AlₓO₂ (0<x<0.2), a spinel-type active material in which transition metals are partially substituted with dissimilar metals, such as Li₁₊ₓMn_{2-x-y}M_{y}O₄ (M is at least one of Al, Mg, Co, Fe, Ni, and Zn, and 0<x+y<2), or a lithium titanate such as Li₄Ti₅O₁₂.

The sulfide active material may include copper Chevrel, iron sulfide, cobalt sulfide, nickel sulfide, or the like.

The solid electrolyte may include at least one selected from the group consisting of an oxide-based solid electrolyte, a sulfide-based solid electrolyte, a polymer electrolyte, and combinations thereof. However, it is preferable to use a sulfide-based solid electrolyte having a high lithium ion conductivity.

The sulfide-based solid electrolyte is not particularly limited, but examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (here, m and n are positive integers, and Z is any one of Ge, Zn, and Ga), Li₂S—GeS₂, Li₂S—SiS₂—Li₃PO₄, Li₂S—SiS₂—LiₓMO_{y} (here, x and y are positive integers, and M is any one of P, Si, Ge, B, Al, Ga, and In), and Li₁₀GeP₂S₁₂.

The oxide-based solid electrolyte may include perovskite-type LLTO (Li₃ₓLa_{2/3-x}TiO₃) and phosphate-based NASICON-type LATP (Li₁₊ₓAlₓTi₂₋ₓ(PO₄)₃).

The polymer electrolyte may include a gel polymer electrolyte, a solid polymer electrolyte, or the like.

The conductive material may include carbon black, conductive graphite, ethylene black, graphene, or the like.

The binder may be the same as the binder used for the intermediate layer 20, but may not be limited thereto. The binder may include butadiene rubber, nitrile butadiene rubber, hydrogenated nitrile butadiene rubber, polyvinylidene fluoride (PVDF), polytetrafluoroethylene (PTFE), and carboxymethyl cellulose (CMC).

The cathode current collector 50 may be an electrically conductive plate-shaped substrate. Specifically, the cathode current collector 50 may be in the form of a sheet or a thin film.

The cathode current collector 50 may include at least one material selected from the group consisting of In, Cu, Mg, Al, stainless steel (SUS), Fe, and combinations thereof.

The present disclosure will be described in more detail with examples described below. The examples described below are presented only to help understanding of the present disclosure, and the scope of the present disclosure is not limited thereto.

### Preparation Example

Spandex was prepared as a polymer, and aminophenyl disulfide was prepared as a linker. The polymer and the linker were added to N-methylpyrrolidone, which is a solvent. The dosage of the linker was adjusted to match the moles of the polymer. An acetic acid solution, which is an acid catalyst, was added to the prepared solution described above, and the resulting mixture was stirred to induce a crosslinking reaction. Thus, a binder was prepared.

FIG. 3 shows Fourier-transform infrared spectroscopy (FT-IR) analysis on the binder according to the preparation example. Polymers that were not crosslinked were also analyzed as controls. Referring to FIG. 3, the binder according to the preparation example exhibits a very weak —C═O bond at about 1, 700 cm⁻¹.

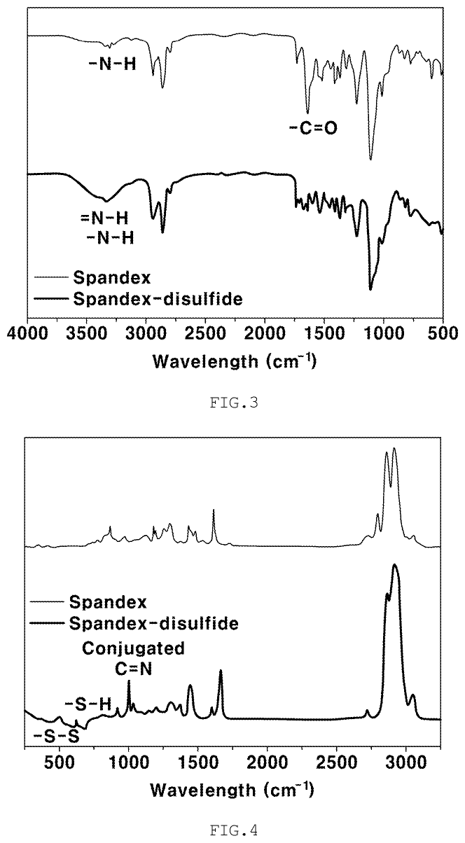

FIG. 4 shows Raman spectroscopy analysis on the binder according to the preparation example. Polymers that were not crosslinked were also analyzed as controls. Referring to FIG. 4, the binder according to the preparation example is identified to exhibit a —C═N bond at 1000 cm⁻¹.

Referring to FIGS. 3 and 4, the carbonyl group (—C═O) of the polymer is converted into a —C═N bond.

The elasticity of the binder according to the preparation example, an uncrosslinked polymer (Spandex), and polyvinylidene fluoride (PVDF) was measured through nano-indentation analysis. The results are shown in Table 1 below.

TABLE 1

| | Elastic | Elastic | Plastic | Elastic |
|---|---|---|---|---|
| | recovery | strain | strain | strain |
| Binder | ratio | (pJ) | (pJ) | ratio |
| Preparation | 0.77 | 173.8 | 124.6 | 1.39 |
| Example | | | | |
| Spandex | 0.74 | 159.4 | 120.7 | 1.32 |
| PVDF | 0.45 | 33.6 | 80.4 | 0.42 |

Elastic recovery ratio=elastic recovery depth/maximum penetration depth
Elastic strain: The degree of elastic recovery is measured in units of force (in joules)
Plastic strain: The degree of plastic strain is measured in units of force (in Joules)
Elastic strain ratio=elastic strain/plastic strain

The elastic recovery force can be quantified by the elastic recovery depth and the elastic strain ratio.

The elastic recovery depth refers to the ratio of the height that returns when a predetermined force is applied to a polymer film.

The elastic strain ratio is the ratio of elastic strain to plastic strain. When the elastic strain ratio is greater than 1, the polymer may be regarded as a polymer that is not plastically deformed but elastically recovers.

Referring to Table 1, the binder according to the preparation example is excellent in elastic recovery ratio, elastic strain ratio, and elastic strain compared to Spandex, which is an uncrosslinked polymer, or polyvinylidenefluoride (PVDF).

### Example

A half-cell was manufactured using the binder according to the preparation example. The half-cell includes a lithium foil, a solid electrolyte layer, an intermediate layer, and an anode current collector. The intermediate layer includes about 30% by weight of a metal, about 65% by weight of a carbon material, and about 5% by weight of the binder according to the preparation example.

### Comparative Example 1

A half-cell was manufactured in the same manner as in Example except that Spandex, which is an uncrosslinked polymer, was used.

### Comparative Example 2

A half-cell was manufactured in the same manner as in Example except that polyvinylidenefluoride (PVDF) was used.

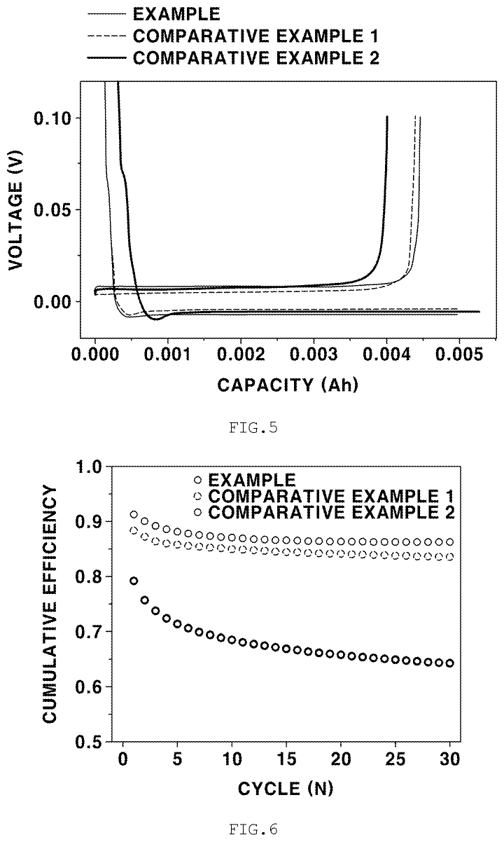

FIG. 5 shows first charging and discharging cycle of the half cells according to Example, Comparative example 1, and Comparative example 2. The current density was 1 mAh/cm² and the deposition capacity was 3 mAh/cm². The initial efficiency of Comparative Example 2 was 79%, and the initial efficiency of Comparative Example 1 was 88%. The example, on the other hand, had an initial efficiency of 91%. That is, the initial efficiency was improved in the case of Example.

FIG. 6 shows cumulative efficiency of the half cells according to Example, Comparative Example 1, and Comparative Example 2. Example showed a superior efficiency compared to Comparative Example 2. The cumulative efficiency of Comparative Example 1 after 30 cycles was 85%, and the cumulative efficiency of Example was 88%. The analysis result shows that as the stability and elasticity of the binder according to the preparation example are improved, the cycle efficiency of the cell using the binder are accordingly improved.

Although embodiments according to the present disclosure have been described for illustrative purposes, those skilled in the art will appreciate that various modifications, additions and substitutions are possible, without departing from the scope and spirit of the disclosure as disclosed in the appended claims

What is claimed is:

1. A binder for a lithium secondary battery comprising:
a polymer comprising a carbonyl group; and
a linker comprising amino groups at both ends,
wherein the binder is in state of crosslinked, and
all or a part of an oxygen atom of the carbonyl group are substituted with a nitrogen atom of the amino groups such that a first end of the linker is bonded to the carbonyl group of one polymer and a second end of the linker is bonded to the carbonyl group of another polymer.

2. The binder of claim 1, wherein the polymer comprises a polyurethane-based polymer.

3. The binder of claim 1, wherein the linker comprises at least one of aminophenyl disulfide, polyethyleneimine, or any combination thereof.

4. The binder of claim 1, wherein the binder is represented by Formula 1: 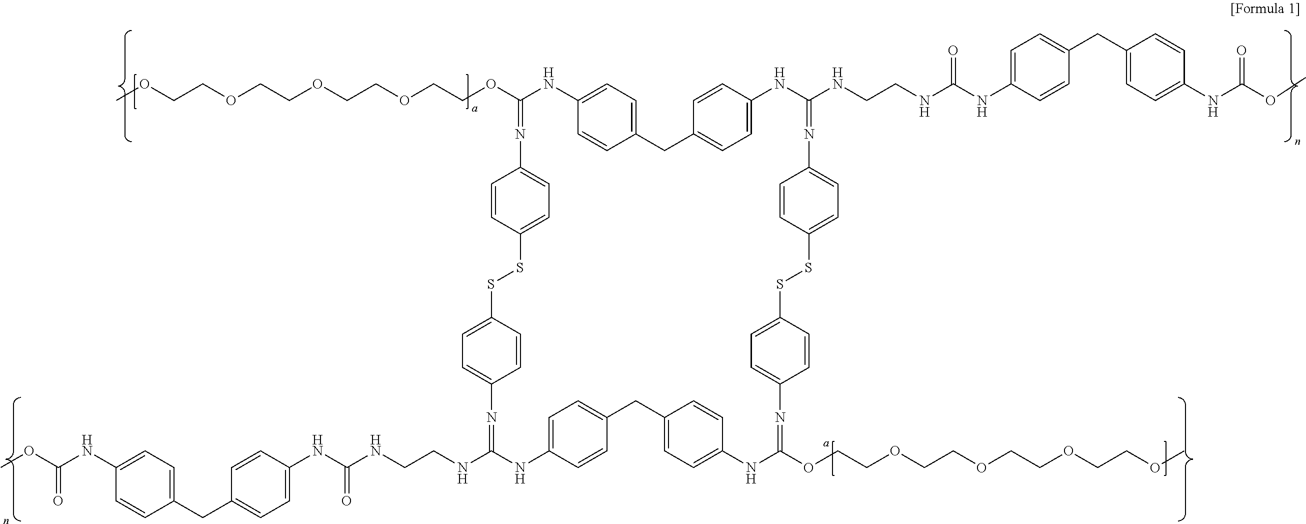
wherein, n is a number of 10 to 10,000 and a is a number of 1 to 100.

5. A lithium secondary battery comprising:
an anode current collector;
an intermediate layer disposed on the anode current collector;
a solid electrolyte layer disposed on the intermediate layer;
a cathode active material layer disposed on the solid electrolyte layer; and
a cathode current collector disposed on the cathode active material layer,
wherein the intermediate layer comprises a metal capable of forming an alloy with lithium and a binder, wherein the binder comprises a polymer comprising a carbonyl group and a linker comprising amino groups at both ends, the binder is in state of crosslinked, and all or a part of an oxygen atom of the carbonyl group are substituted with a nitrogen atom of the amino groups such that a first end of the linker is bonded to the carbonyl group of one polymer and a second end of the linker is bonded to the carbonyl group of another polymer.

6. The lithium secondary battery of claim 5, wherein the metal comprises at least one of gold (Au), platinum (Pt), palladium (Pd), silicon (Si), silver (Ag), aluminum (Al), bismuth (Bi), tin (Sn), zinc (Zn), or any combination thereof.

7. A method of preparing a binder for a lithium secondary battery comprising:
reacting a polymer having a carbonyl group with a linker having amino groups at both ends in the presence of an acid catalyst,
wherein the binder is in state of crosslinked, and
all or a part of an oxygen atom of the carbonyl group are substituted with a nitrogen atom of the amino groups such that a first end of the linker is bonded to the carbonyl group of one polymer and a second end of the linker is bonded to the carbonyl group of another polymer.

8. The method of claim 7, wherein the acid catalyst comprises an acetic acid solution having a concentration of about 1% to 50% by volume.

9. The method of claim 7, wherein the acid catalyst has a pH value of about pH 3 to pH 6.

10. The method of claim 7, wherein the polymer comprises a polyurethane-based polymer.

11. The method of claim 7, wherein the linker comprises at least one of aminophenyl disulfide, polyethyleneimine, or any combination thereof.

12. The method according to claim 7, wherein the binder is represented by Formula 1: 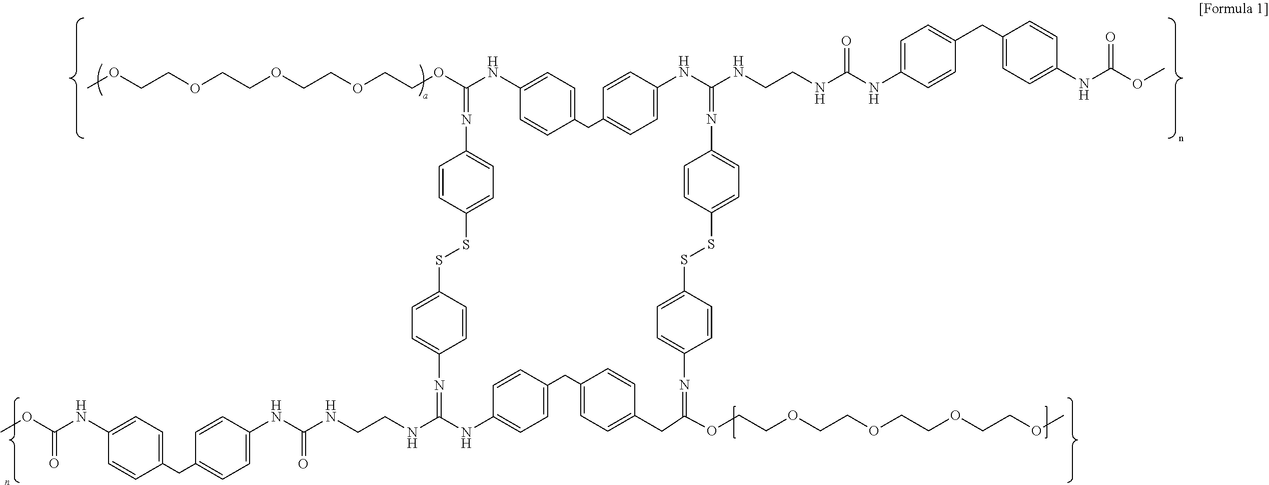
wherein, n is a number of 10 to 10000 and a is a number of 1 to 100.
